(19) United States
(12) Patent Application Publication
(10) Pub. No.: US 2016/0060092 A1
(43) Pub. Date: Mar. 3, 2016

(54) INTERACTIVE ELECTRONIC FLUID DISPENSING APPARATUS

(71) Applicants: DEEPAK HARICHARAN VITTALDEVARA, PLEASANTON, CA (US); SWATHI ISUKAPALLI, PLEASANTON, CA (US); SINDHURA KILARU, MILPITAS, CA (US); SRINIVASA VENUGOPAL KOLLURI, MILPITAS, CA (US)

(72) Inventors: DEEPAK HARICHARAN VITTALDEVARA, PLEASANTON, CA (US); SWATHI ISUKAPALLI, PLEASANTON, CA (US); SINDHURA KILARU, MILPITAS, CA (US); SRINIVASA VENUGOPAL KOLLURI, MILPITAS, CA (US)

(21) Appl. No.: 14/470,257

(22) Filed: Aug. 27, 2014

(51) Int. Cl. B67D 7/30; B67D 7/62

(52) U.S. Cl. CPC B67D 7/301; B67D 7/62

(57) ABSTRACT

An interactive electronic fluid dispensing apparatus allows a user to select a desired amount of fluid to be dispensed. The apparatus includes a housing unit with an inlet pipe and an outlet pipe, the inlet pipe being coupled to a fluid container, a control assembly disposed within the housing unit and operably connected to the inlet pipe and the outlet pipe, a microprocessor disposed within the housing unit and coupled to a power source, and a user interface affixed to the housing unit and operably connected to the microprocessor. The user interface receives an input corresponding to a fluid amount selected from a plurality of fluid amounts. This enables the microprocessor to transmit signals to the control assembly to extract the selected fluid amount from the container through the inlet pipe and dispense the fluid amount through the outlet pipe.

### BACKGROUND

The embodiments herein relate generally to devices for dispensing fluids.

Individuals use a wide variety of fluids every day such as soaps, shampoos, conditioners, lotions, moisturizers and food items such as sauces and condiments including, but not limited to, ketchup, mustard, mayonnaise, or the like. These fluids are typically dispensed from a container by squeezing the container or using a mechanical component such as a hand pump. However, these storage containers are undesirable because they are difficult to use and/or inefficient. In particular, these containers do not easily dispense fluid that remains on the bottom or side walls of the container. This results in a 5-10% waste of product and money. In addition, these containers do not dispense a specific quantity of fluid desired by a user.

U.S. Patent Application Publications 2013/0140323 and 2013/0264355, and U.S. Pat. No. 8,573,443 disclose a variety of soap and/or fluid dispensers. However, these devices are disadvantageous because they do not allow a user to efficiently select a desired quantity of fluid to be dispensed from a plurality of predetermined quantities. In addition, these devices are limited because they can only be used with certain sized fluid containers. This is because the fluid containers are stored within the housing members of the devices.

As such, there is a need in the industry for a fluid dispensing apparatus that efficiently dispenses a desired amount of fluid from a container, which overcomes the limitations of the prior art.

### SUMMARY

An interactive electronic fluid dispensing apparatus configured to allow a user to select a desired amount of fluid to be dispensed is provided. The apparatus comprises a housing unit comprising an inlet pipe and an outlet pipe, wherein the inlet pipe is detachably coupled to a fluid container, a control assembly disposed within the housing unit and operably connected to the inlet pipe and the outlet pipe, a microprocessor disposed within the housing unit and coupled to a power source, and a user interface affixed to the housing unit and operably connected to the microprocessor, wherein the user interface is configured to receive an input corresponding to a fluid amount selected from a plurality of fluid amounts, thereby enabling the microprocessor to transmit signals to the control assembly to extract the selected fluid amount from the container through the inlet pipe and dispense the fluid amount through the outlet pipe.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the electronic fluid dispensing apparatus in use;

FIG. 2 depicts a perspective view of certain embodiments of the electronic fluid dispensing apparatus;

FIG. 3 depicts a cutaway view of certain embodiments of the electronic fluid dispensing apparatus;

FIG. 4 depicts a section view of certain embodiments of the electronic fluid dispensing apparatus taken along line 4-4 in FIG. 1 demonstrating the fluid pathway;

FIG. 5 depicts a section view of certain embodiments of the electronic fluid dispensing apparatus taken along line 5-5 in FIG. 4;

FIG. 6 depicts a section view of certain embodiments of the electronic fluid dispensing apparatus demonstrating the outgoing fluid pathway;

FIG. 7 depicts a cutaway view of certain embodiments of the electronic fluid dispensing apparatus demonstrating the rotation of outlet pipe 28; and

FIG. 8 depicts a schematic view of certain embodiments of the electronic fluid dispensing apparatus.

### DETAILED DESCRIPTION OF CERTAIN EMBODIMENTS

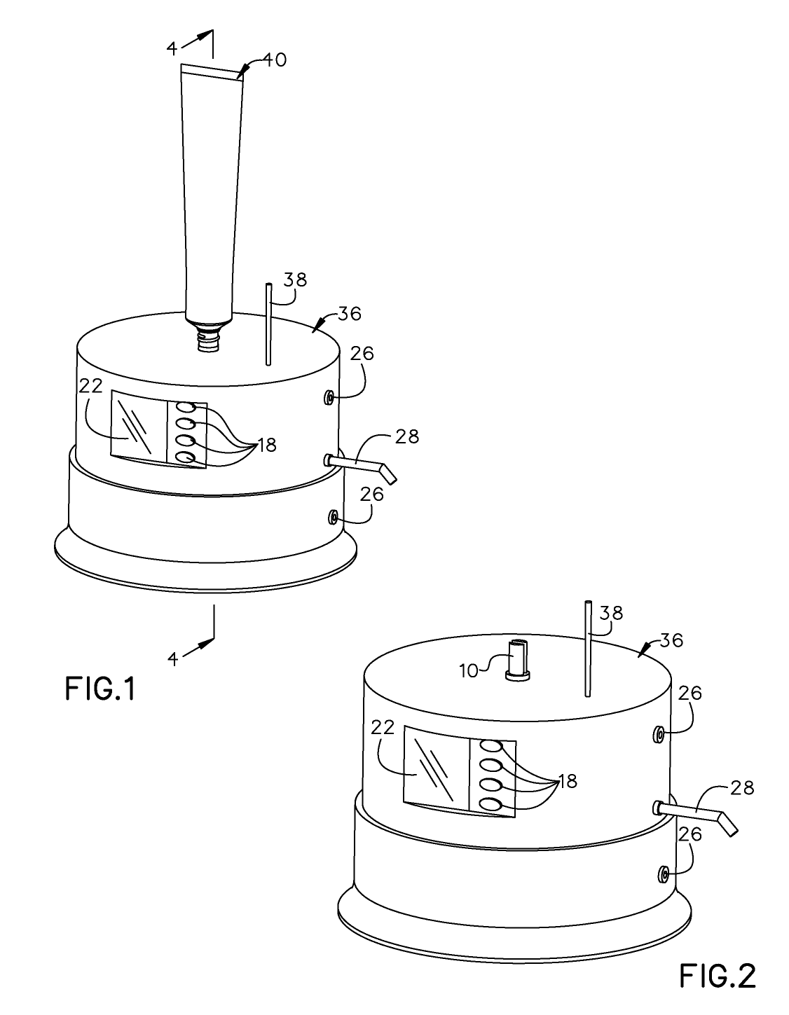

As depicted in FIGS. 1-2, the electronic fluid dispensing apparatus is configured for use with fluid container 40. The electronic fluid dispensing apparatus comprises housing 36, inlet pipe 10, outlet pipe 28, piston 38, motion sensors 26, and a user interface comprising display 22 and input buttons 18. Fluid container 40 is the original container used to store any type of fluid with any viscosity. The fluid may be, but is not limited to, soaps, shampoos, conditioners, lotions, moisturizers and food items such as sauces and condiments such as ketchup, mustard, mayonnaise, or the like. Fluid container 40 is oriented upside down to enable the cap of the container to be secured over inlet pipe 10. Since fluid container 40 is positioned outside of housing 36, any sized and shaped fluid container 40 may be used. It shall be appreciated that inlet pipe 10 is configured to accommodate different sized caps of fluid container 40.

In a preferred embodiment, display 22 is a LCD display. However, any alternative type of display known in the field may be used such as a LED display. Display 22 may be a touch screen display, which eliminates the need for input buttons 18. It shall be appreciated that display 22 may present to a user any variety of information including, but not limited to, amount of fluid to be dispensed, amount of fluid remaining in the container, time and date information, or the like.

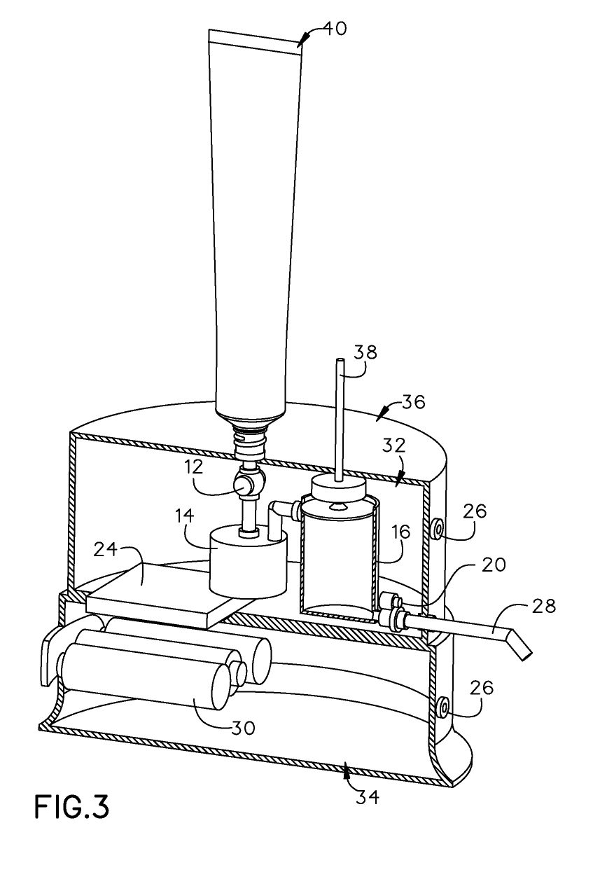

As depicted in FIG. 3, the electronic fluid dispensing apparatus further comprises component compartment 32 and battery compartment 34. Control valve 12, vacuum pump 14, container 16 and motherboard 24 are housed within component compartment 32. Control valve 12 is connected to inlet pipe 10 and is configured to control the flow of fluid from fluid container 40 into the apparatus. Specifically, control valve 12 opens and closes the pathway after inlet pipe 10. Vacuum pump 14 is connected to control valve 12 by a pipe and is configured to provide the required suction forces to draw fluid from fluid container 40 into the apparatus. Apparatus container 16 is connected to vacuum pump 14 and outlet pipe 28. Apparatus container 16 temporarily stores fluid pumped by vacuum pump 14 prior to being dispensed via outlet pipe 28. Piston 38 is operably connected to apparatus container 16 and is configured to enable the transfer of fluid from apparatus container 16 to outlet pipe 28. Outlet rotor 20 is connected to outlet pipe 28 and is configured to rotate outlet pipe 28 to a desired position.

Motherboard 24 comprises any electrical components known in the field such as control chips, microprocessors, memory storage units, or the like. It shall be appreciated that motherboard 24 comprises any computer programs and/or algorithms required to implement the functionality of the apparatus. Input buttons 18, motion sensors 26, display 22, control valve 12, vacuum pump 14, piston 38 and outlet rotor 20 are operably connected to motherboard 24 by wires (not shown). Batteries 30 are secured within battery compartment 34 and are configured to supply power to motherboard 24. In a preferred embodiment, batteries 30 comprise three AAA batteries. However, it shall be appreciated that an alternative number and type of batteries can be used instead. In an alternative embodiment, the electronic fluid dispensing apparatus may be directly connected to an external power outlet.

In operation, a user secures the cap of fluid container 40 around inlet pipe 10 of the electronic fluid dispensing apparatus. The user controls the apparatus via input buttons 18. In an embodiment of the invention, a first input button 18 is an On/Off switch, which enables and disables the apparatus. A second input button 18 allows a user to select a fluid amount to be dispensed from a plurality of predetermined fluid amounts. For example, the user can depress the second input button 18 to select 1 ml, 5 ml, 7 ml or 10 ml. However, it shall be appreciated that motherboard 24 can be easily reprogrammed to include any alternative group of fluid amounts. A third input button 18 allows the apparatus to dispense fluid from fluid container 40 in a continuous mode. A fourth input button 18 controls outlet rotor 20, which rotates outlet pipe 28 to a desired position. Display 22 presents to the user a status of the apparatus and any inputs entered via input buttons 18.

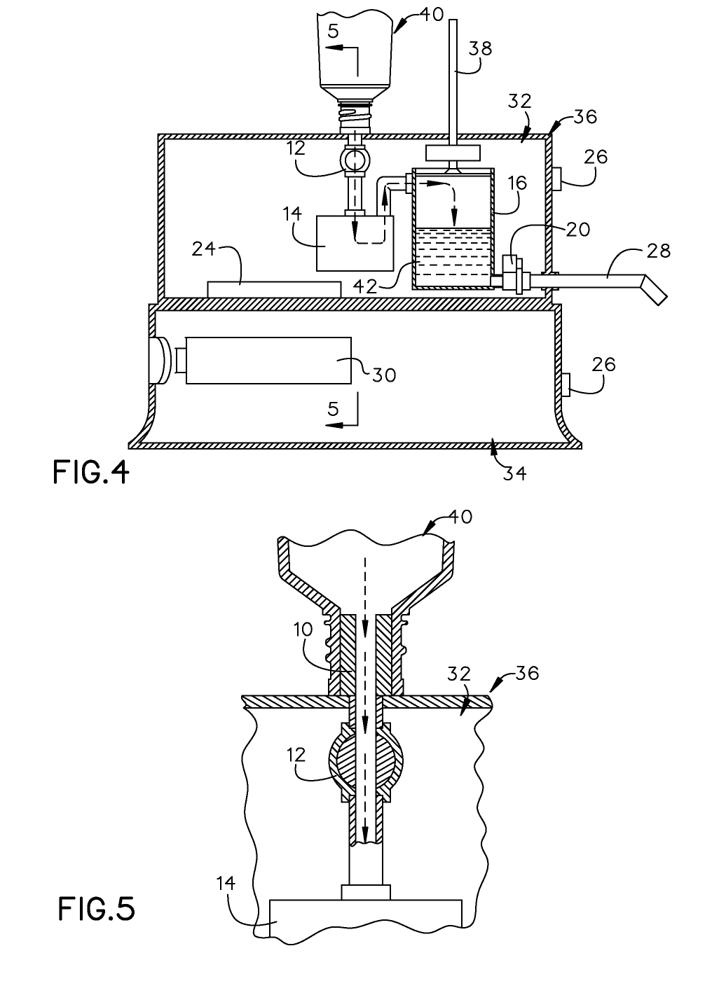

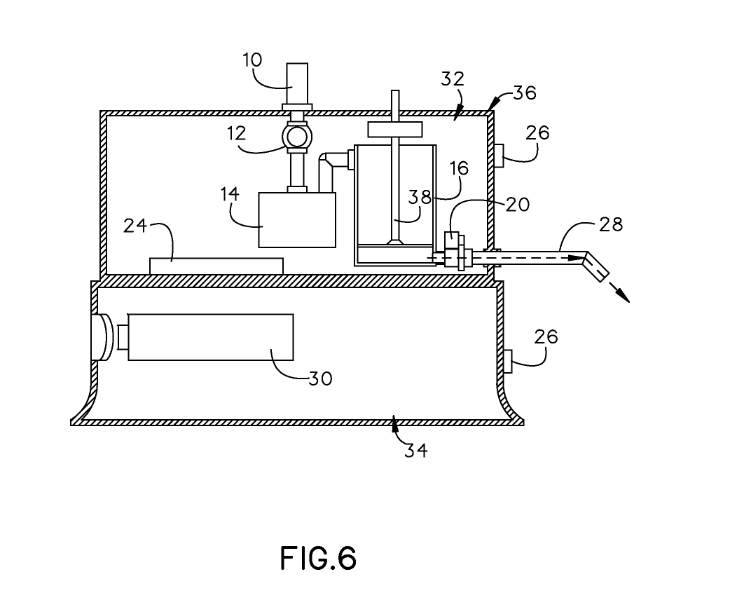

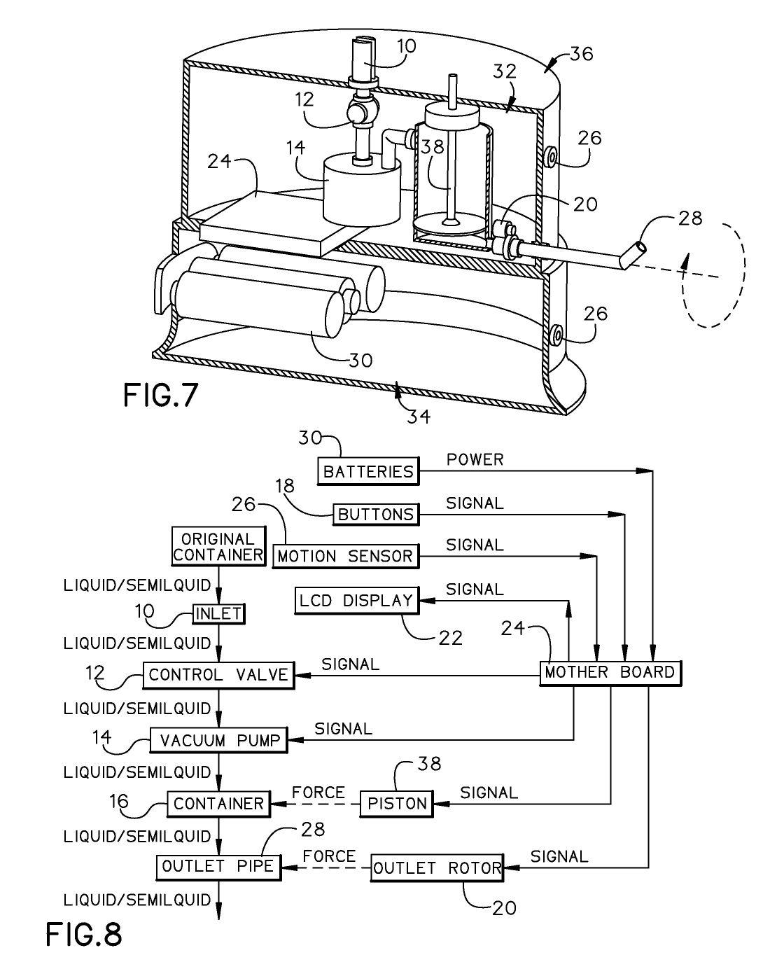

A user selects a desired fluid amount via input button 18. The electronic fluid dispensing apparatus extracts the selected amount of fluid 42 from fluid container 40. Fluid 42 follows the pathway shown in FIG. 4. As depicted in FIG. 5, motherboard 24 transmits a signal to control valve 12 to adjust the valve to an open position. Motherboard 24 then transmits a signal to vacuum pump 14 to provide a sufficient suction force to transport the selected amount of fluid 42 from fluid container 40 to apparatus container 16. Motion sensors 26 enable and disable motherboard 24. When sensors 26 detect motion from an object such as a user's hand, arm or the like, a signal is transmitted to motherboard 24, which relays the signal to piston 38. As depicted in FIG. 6, piston 38 receives the signal from motherboard 24 and compresses to apply a downward force to transport fluid 42 through outlet pipe 28. The user captures dispensed fluid 42 from the end of outlet pipe 28. Once fluid 42 is dispensed out of outlet pipe 28, piston 38 decompresses and returns to its original position. The user can repeat this process as many times as desired or select a continuous dispensing mode via the third input button 18. In one embodiment of the invention, the user can depress the fourth input button to rotate outlet pipe 28 to a desired position. As depicted in FIG. 7, outlet pipe 28 can rotate 360 degrees to the desired position.

FIG. 8 depicts a schematic view of the components of the electronic fluid dispensing apparatus. Batteries 30 directly supply power to motherboard 24. Motherboard 24 receives signals from input buttons 18 and motion sensors 26. Motherboard 24 transmits signals to control valve 12, vacuum pump 14, piston 38 and outlet rotor 20 to enable the functionality of the apparatus. Motherboard 24 transmits signals to display 22 to provide the user with the status of the apparatus.

It shall be appreciated that the components of the electronic fluid dispensing apparatus described in several embodiments herein may comprise any known materials in the field and be of any color, size and/or dimensions. It shall be appreciated that the components of the electronic fluid dispensing apparatus described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An interactive electronic fluid dispensing apparatus configured to allow a user to select a desired amount of fluid to be dispensed, the apparatus comprising:
a housing unit comprising an inlet pipe and an outlet pipe, wherein the inlet pipe is detachably coupled to a fluid container;
a control assembly disposed within the housing unit and operably connected to the inlet pipe and the outlet pipe;
a microprocessor disposed within the housing unit and coupled to a power source; and
a user interface affixed to the housing unit and operably connected to the microprocessor, wherein the user interface is configured to receive an input corresponding to a fluid amount selected from a plurality of fluid amounts, thereby enabling the microprocessor to transmit signals to the control assembly to extract the selected fluid amount from the container through the inlet pipe and dispense the fluid amount through the outlet pipe.

2. The apparatus of claim 1, wherein the control assembly comprises a control valve coupled to the inlet pipe and a vacuum pump coupled to the control valve, wherein the vacuum pump is configured to transport the selected fluid amount to a storage container disposed within the housing unit.

3. The apparatus of claim 2, wherein the control assembly further comprises a piston coupled to the storage container, wherein the piston is configured to transport the selected fluid amount in the storage container to the outlet pipe.

4. The apparatus of claim 3, further comprising a rotor coupled to the outlet pipe, wherein the rotor is configured to rotate the outlet pipe to a desired position.

5. The apparatus of claim 3, further comprising motion sensors affixed to the housing unit, wherein the motion sensors are configured to enable or disable the microprocessor.

6. The apparatus of claim 3, wherein the user interface comprises a display unit and a plurality of input buttons.

7. The apparatus of claim 3, wherein the power source is at least one battery.
